(19) United States
(12) Patent Application Publication
(10) Pub. No.: US 2026/0262097 A1
(43) Pub. Date: Sep. 3, 2026

(54) PRACH TRANSMISSION POWER CONTROL WITH TRANSMISSION INDEX WITHIN PDCCH ORDER

(71) Applicant: InterDigital Patent Holdings, Inc., Wilmington, DE (US)

(72) Inventors: Erdem Bala, East Meadow, NY (US); Paul Marinier, Brossard (CA); Brian Martin, Farnham (GB); Oumer Teyeb, Montreal (CA); Dylan Watts, Montreal (CA); Martino Freda, Laval (CA)

(73) Assignee: InterDigital Patent Holdings, Inc., Wilmington, DE (US)

(21) Appl. No.: 19/162,271

(22) PCT Filed: Apr. 3, 2024
(86) PCT No.: PCT/US2024/022821

§ 371 Date: Sep. 4, 2025

Related U.S. Application Data
(60) Provisional application No. 63/456,964, filed on Apr. 4, 2023.
(60) Provisional application No. 63/465,415, filed on May 10, 2023.

(51) Int. Cl. H04W 74/0833; H04W 52/14; H04W 52/36

(52) U.S. Cl. CPC H04W 74/0833; H04W 52/143; H04W 52/367

(57) ABSTRACT

A wireless transmit/receive unit (WTRU) receives a physical downlink control channel (PDCCH) order for a random access channel (RACH) preamble transmission to a candidate cell. The PDCCH order includes a retransmission attempt index. The WTRU transmits a physical RACH (PRACH) retransmission using a transmit power that is based on the retransmission attempt index. When the retransmission attempt index indicates that the PRACH retransmission is a next PRACH transmission after a previous PRACH transmission attempt, the transmit power is increased by an offset of the transmit power for the previous PRACH transmission. When the retransmission attempt index indicates that the PRACH retransmission is not a next PRACH transmission after a previous PRACH transmission attempt, the transmit power is increased based on a last successfully received PDCCH order.

### CROSS-REFERENCE TO RELATED APPLICATION

This application claims priority to U.S. Provisional Patent Application No. 63/456,964 filed Apr. 4, 2023, and to U.S. Provisional Patent Application No. 63/465,415 filed May 10, 2023, the entire contents of each of which are incorporated herein by reference.

### BACKGROUND

A wireless transmit/receive unit (WTRU) may be configured to measure one or more beams of a cell (e.g., in RRC_CONNECTED mode). One or more measurement results (e.g., power values) may be used (e.g., averaged) to derive a cell quality. Cell quality from one or more beam measurements may be derived in a similar way for the one or more serving cell(s) and/or for the non-serving cell(s).

A WTRU may be configured to measure one or more beams of a cell and/or the measurement(s) result(s). In RRC_CONNECTED, for example, the WTRU may measure one or more (e.g., multiple) beam(s) of a cell. One or more measurement(s) result(s) (e.g., power value(s)) may be averaged to derive the cell quality. In doing so, the WTRU may be configured to consider a subset of the one or more detected beam(s). Filtering may take place at one or more (e.g., two) different levels. Filtering may take place at the physical layer to derive beam quality. Filtering may take place at the Radio Resource Control (RRC) level to derive cell quality from one or more (e.g., multiple) beam(s). Cell quality from one or more beam measurement(s) may be derived in a similar (e.g., same) way for the one or more serving cell(s) and for the non-serving cell(s). One or more measurement reports may include the one or more measurement results of the one or more X strongest (e.g., best) beam(s), for example, if the WTRU is configured to do so by the gNB.

### SUMMARY

A wireless transmit/receive unit (WTRU) may be configured with respect to physical random access channel (PRACH) power control based on time difference between one or more physical downlink control channel (PDCCH) order(s). The WTRU may be configured with respect to PRACH power control with transmission index within PDCCH order. The WTRU may be configured with respect to PRACH power control based on one or cell measurement(s).

A WTRU may be configured to perform PRACH power control based on time difference between PDCCH orders. The WTRU may perform one or more of the following. The WTRU may reset the power ramping counter for a first cell (e.g., may set the counter to 1). The WTRU may receive a PDCCH order for a Random Access Channel (RACH) preamble transmission to a first cell (e.g., a candidate cell). The WTRU may determine a time difference between a time when the PDCCH order was received and a time when a previous PDCCH order was received.

If the ID of cell indicated in the PDCCH order is the same ID as in a previous PDCCH order, and under the condition that the time difference between when the current PDCCH order and the previous PDCCH order was received is less than a threshold, the WTRU may perform one or more of the following. The WTRU may determine (e.g., set) a first power ramping counter value equal to the power ramping counter plus one (e.g., power ramping counter=power ramping counter+1). The WTRU may determine a first PRACH transmit power, for example, based on the first determined power ramping counter. The WTRU may transmit a first PRACH, for example, using the determined first PRACH power.

If the ID of cell indicated in the PDCCH order is the same ID as in a previous PDCCH order, and under the condition that the time difference between when the current PDCCH order and the previous PDCCH order was received is greater than or equal to a threshold, the WTRU may perform one or more of the following. The WTRU may determine (e.g., reset) a second power ramping counter value. The WTRU may determine a second PRACH transmit power, for example, using the determined second power ramping counter. The WTRU may transmit the PRACH, for example, using the determined second PRACH transmit power.

The WTRU may determine the PRACH transmit power if a cell ID in the PDCCH order is the same as in a previous PDCCH order. The WTRU may determine the PRACH transmit power based on the indication in the PDCCH order. The previous PDCCH order may include a first cell identifier (e.g., a first physical cell identifier (PCI)) and/or a first RS index. The WTRU may determine that the PDCCH order is a retransmission when the PDCCH order comprises the first cell identifier and/or the first RS index. The WTRU may increase the power ramping counter based on an indication in the PDCCH order.

A wireless transmit/receive unit (WTRU) may receive a physical downlink control channel (PDCCH) order for a random access channel (RACH) preamble transmission to a candidate cell. The PDCCH order may include a retransmission attempt index. The WTRU may transmit a physical RACH (PRACH) retransmission using a transmit power that is based on the retransmission attempt index. When the retransmission attempt index indicates that the PRACH retransmission is a next PRACH transmission after a previous PRACH transmission attempt, the transmit power may be increased by an offset of the transmit power for the previous PRACH transmission. When the retransmission attempt index indicates that the PRACH retransmission is not a next PRACH transmission after a previous PRACH transmission attempt, the transmit power may be increased based on a last successfully received PDCCH order.

The PDCCH transmission may include downlink control information (DCI). The WTRU may determine the transmit power based on a transmission index included in the DCI. The DCI may include a bitfield. The WTRU may determine the transmit power based on the bitfield.

The WTRU may receive configuration information including an association of the retransmission attempt index and/or the transmit power to determine the transmit power based on the association of the received retransmission attempt index and/or the configured transmit power.

The WTRU may reset the retransmission attempt index, for example, when the retransmission attempt index reaches a maximum value. The WTRU may determine the retransmission attempt index, for example, based on an association of the retransmission attempt index and a control resource set (CORESET) in which the PDCCH is received. The WTRU start and/or restart a validity timer, for example, when a PDCCH order is received. The WTRU may, when the validity timer expires, reset a counter value for the candidate cell. The WTRU may determine the transmit power based on an association of a counter and the retransmission attempt index. The counter may be a fixed value. The WTRU may determine, when the counter is a fixed value, the transmit power based on the retransmission attempt index and the fixed value.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts a system diagram illustrating an example of a (e.g., high-level) measurement model.

FIG. 3 depicts a diagram illustrating an example of L1/2 inter-cell mobility using CA.

### DETAILED DESCRIPTION

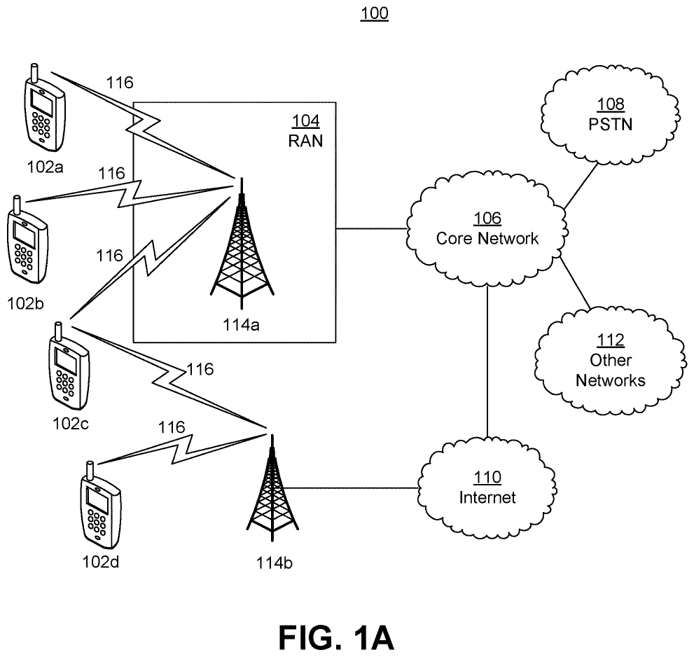

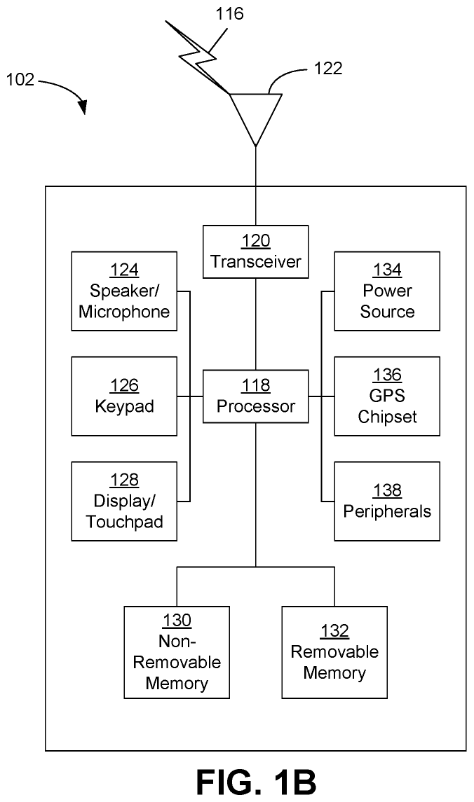

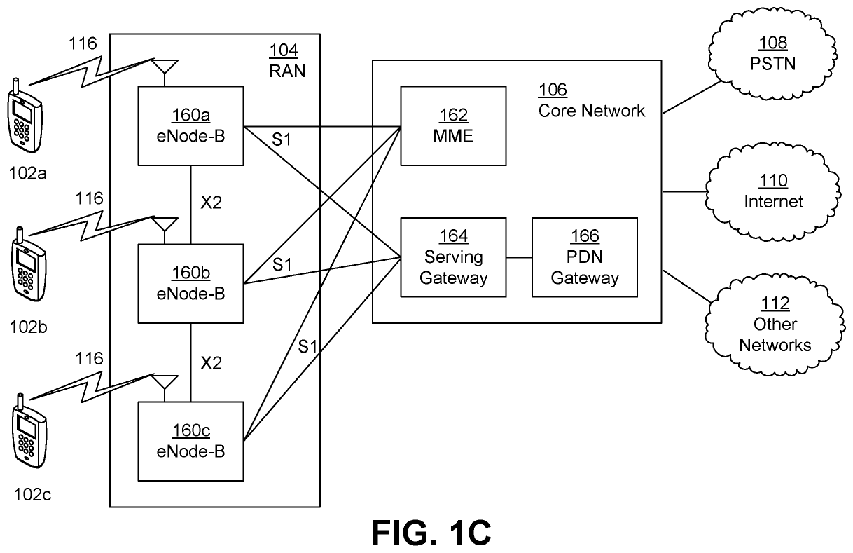

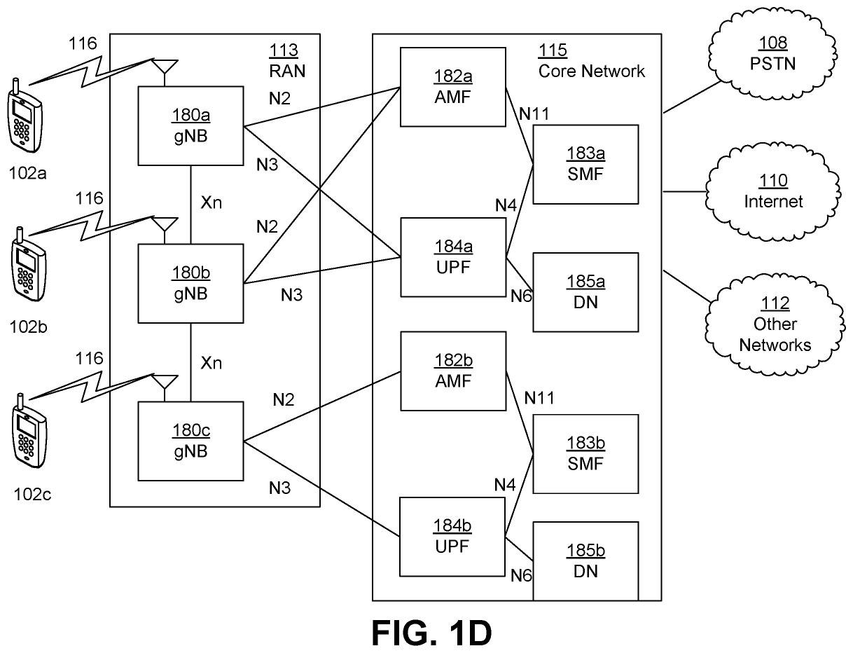

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may be configured to measure one or more beams of a cell and/or the measurement(s) result(s). In RRC_CONNECTED, for example, the WTRU may measure one or more (e.g., multiple) beam(s) of a cell. One or more measurement(s) result(s) (e.g., power value(s)) may be averaged to derive the cell quality. In doing so, the WTRU may be configured to consider a subset of the one or more detected beam(s). Filtering may take place at one or more (e.g., two) different levels. Filtering may take place at the physical layer to derive beam quality. Filtering may take place at the Radio Resource Control (RRC) level to derive cell quality from one or more (e.g., multiple) beam(s). Cell quality from one or more beam measurement(s) may be derived in a similar (e.g., same) way for the one or more serving cell(s) and for the non-serving cell(s). One or more measurement reports may include the one or more measurement results of the one or more X strongest (e.g., best) beam(s), for example, if the WTRU is configured to do so by the gNB.

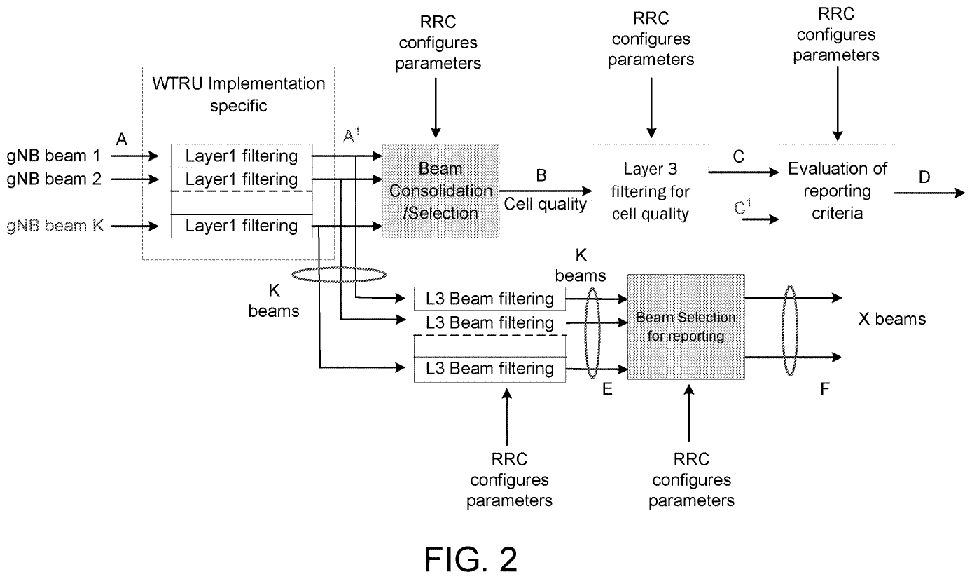

FIG. 2 depicts a system diagram illustrating an example high-level measurement model.

A WTRU may be configured with respect to Channel State Information (CSI) reporting. CSI may be used as an indicator from the WTRU to the network on how good or bad) a channel is at any point in time. CSI may be used by the gNB to make one or more scheduling determinations (e.g., selection of Modulation) and/or to assist with beamforming.

The one or more time and/or frequency resource(s) that may be used by the WTRU to report CSI may be controlled by the gNB. CSI may include one or more of: Channel Quality Indicator (CQI), precoding matrix indicator (PMI), CSI-Reference Signal (CSI-RS) resource indicator (CRI), Synchronization Signal (SS)/Physical Broadcast Channel (PBCH) Block Resource indicator (SSBRI), layer indicator (L1), rank indicator (RI), L1-Reference Signal Received Power (RSRP), L1-Signal to Interference Noise Ratio (SINR), and/or Capability [Set] Index.

For CQI, PMI, CRI, SSBRI, L1, RI, L1-RSRP, L1-SINR, and/or Capability [Set] Index, a WTRU may be configured by one or more higher layer(s) with N≥1 CSI-ReportConfig Reporting Settings, M≥1 CSI-ResourceConfig Resource Settings, and/or one or more (e.g., two) list(s) of trigger states (e.g., given by the one or more higher layer parameters CSI-AperiodicTriggerStateList and/or CSI-SemiPersistentOnPUSCH-TriggerStateList). One or more (e.g., each) trigger state in CSI-Aperiodic TriggerStateList may include a list of associated CSI-ReportConfigs indicating the Resource Set IDs for channel and/or for interference. One or more (e.g., each) trigger state in CSI-SemiPersistentOnPUSCH-TriggerStateList may include one or more associated CSI-ReportConfig.

One or more (e.g., each) Reporting Setting CSI-ReportConfig may be associated with a (e.g., single) downlink Bandwidth Part (BWP) (e.g., indicated by higher layer parameter BWP-Id) given in the associated CSI-ResourceConfig for channel measurement and/or may include the one or more parameter(s) for one or more CSI reporting band(s): codebook configuration including codebook subset restriction, time-domain behavior, frequency granularity for CQI and/or PMI, one or more measurement restriction configurations, and/or the one or more CSI-related quantity (ies) to be reported by the WTRU such as the layer indicator (L1), L1-RSRP, L1-SINR, CRI, and/or Synchronization Signal Block (SSB) Resource Indicator (SSBRI), and/or Capability [Set] Index.

The time domain behavior of the CSI-ReportConfig may be indicated by the higher layer parameter reportConfigType and/or may be set to ‘aperiodic’, ‘semiPersistentOnPUCCH’, ‘semiPersistentOnPUSCH’, and/or ‘periodic’. For ‘periodic’ and/or ‘semiPersistentOnPUCCH’ and/or ‘semiPersistentOnPUSCH’ CSI reporting, the configured periodicity and/or slot offset may apply in the numerology of the UL BWP in which the CSI report is configured to be transmitted on. The higher layer parameter reportQuantity may indicate the one or more CSI-related, L1-RSRP-related, L1-SINR-related and/or Capability [Set] Index-related quantity (ies) to report. The reportFreqConfiguration may indicate the reporting granularity in the frequency domain, including the CSI reporting band and/or if PMI and/or CQI reporting is wideband and/or sub-band. The timeRestrictionForChannelMeasurements parameter in CSI-ReportConfig may be configured to enable time domain restriction for one or more channel measurement(s) and/or timeRestrictionForInterferenceMeasurements may be configured to enable time domain restriction for one or more interference measurement(s). Additionally or alternatively, the CSI-ReportConfig may include CodebookConfig, which may include one or more configuration parameters for Type-I, Type II, Enhanced Type II CSI, and/or Further Enhanced Type II Port Selection including codebook subset restriction when applicable, and/or one or more configuration(s) of group-based reporting.

One or more (e.g., each) CSI Resource Setting CSI-ResourceConfig may include a configuration of a list of S≥1 CSI Resource Sets (e.g. given by higher layer parameter csi-RS-ResourceSetList), where the list may include one or more references to one or more (e.g., either, both of) Non-zero power (NZP) CSI-RS resource set(s) and/or SS/PBCH block set(s) or the list is comprised of references to CSI-IM resource set(s). One or more (e.g., each) CSI Resource Setting may be located in the DL BWP identified by the higher layer parameter BWP-id, and/or one or more (e.g., all) CSI Resource Settings linked to a CSI Report Setting may have the same DL BWP.

The time domain behavior of the one or more CSI-RS resource(s) within a CSI Resource Setting may be indicated by the higher layer parameter resourceType and/or may be set to aperiodic, periodic, and/or semi-persistent. For periodic and/or semi-persistent CSI Resource Settings, when the WTRU is configured with groupBasedBeamReporting-r17, the number of CSI Resource Sets configured may be S=2, otherwise the number of CSI-RS Resource Sets configured may be (e.g., limited to) S=1. For periodic and/or semi-persistent CSI Resource Settings, the configured periodicity and/or slot offset may be given in the numerology of its associated DL BWP, as given by BWP-id. When a WTRU is configured with multiple CSI-ResourceConfigs consisting the same NZP CSI-RS resource ID, the same time domain behavior may be configured for the CSI-ResourceConfigs. When a WTRU is configured with one or more (e.g., multiple) CSI-ResourceConfigs including the same CSI-IM resource ID, the same time-domain behavior may be configured for the CSI-ResourceConfigs. One or more (e.g., all) CSI Resource Settings linked to a CSI Report Setting may have the same time domain behavior.

The one or more following may be configured via higher layer signaling for one or more CSI Resource Settings for channel and/or interference measurement. CSI-Interference Measurement (CSI-IM) resource may be configured for one or more interference measurements. NZP CSI-RS resource may be configured for one or more interference measurements. NZP CSI-RS resource may be configured for one or more channel measurements.

The WTRU may be configured with a list of one or more up Transmission Configuration Indicator (TCI)-State configurations. One or more (e.g., each) TCI-State may include one or more parameters for configuring a quasi-co-location relationship between one or more (e.g., two) downlink reference signals and the one or more DM-RS port(s) of the Physical Downlink Shared Channel (PDSCH), the DM-RS port of Physical Downlink Control Channel (PDCCH) and/or the one or more CSI-RS port(s) of a CSI-RS resource. The quasi-co-location relationship may be configured by the higher layer parameter qcl-Type1 for the first DL RS, and/or qcl-Type2 for the second DL RS (e.g., if configured). The one or more quasi-co-location types corresponding to one or more (e.g., each) DL RS may be given by the higher layer parameter qcl-Type in QCL-Info and/or may take one or more of the following values: ‘typeA’; ‘type’; ‘typeC’; and/or ‘typeD’. ‘TypeA’ may include Doppler shift, Doppler spread, average delay, and/or delay spread. ‘TypeB’ may include Doppler Shift and/or Doppler spread. ‘TypeC’ may include Doppler shift and/or average delay. ‘TypeD’ may include one or more Spatial receiver parameter(s).

A WTRU may be configured with respect to inter-cell L1/2 mobility. Inter-cell L1/2 mobility may be used to manage the one or more beams in carrier aggregation (CA) case, but cell change and/or cell add may not be supported. One or more of the objectives of the WI “Further NR Mobility Enhancements” may be to specify one or more mechanism(s) and/or procedure(s) of L1/L2 based inter-cell mobility for mobility latency reduction. A WTRU may be configured with respect to L1/L2 based mobility and/or inter-cell beam management that includes one or more intra-DU and/or intra-frequency scenarios. In examples, the serving cell may remain unchanged (e.g., there may be no possibility to change the serving cell using L1/2 based mobility). In one or more FR2 deployment(s), CA may be used to exploit the available bandwidth, e.g., to aggregate one or more (e.g., multiple) Component Carriers (CCs) in one band. These CCs may be transmitted with the same analog beam pair (e.g., gNB beam and/or WTRU beam). The WTRU may be configured with one or more TCI state(s) (e.g., may have fairly large number) for reception of PDCCH and/or PDSCH. For example, a WTRU may be configured with sixty four (64) TCI states for reception of PDCCH and/or PDSCH. One or more (e.g., each) TCI state may include a RS and/or SSB that the WTRU refers to for setting its beam. The SSB may be associated with a non-serving Physical Cell Identification (PCI). Medium access control (MAC) signaling (e.g., “TCI state indication for WTRU-specific PDCCH MAC CE”) may activate the TCI state for a Coreset/PDCCH. Reception of PDCCH from a non-serving cell may be supported by MAC Control Element (CE) indicating a TCI state associated to non-serving PCI. MAC signaling (e.g., “TCI States Activation/Deactivation for WTRU-specific PDSCH”) may activate a subset of (e.g., up to) 8 TCI states for PDSCH reception. Downlink Control Information (DCI) may indicate which of the 8 TCI states. The WTRU may be configured to support “unified TCI state” with one or more different updating mechanisms (e.g., DCI-based) and/or with multi-TRP.

One or more objective(s) of L1/2 inter-cell mobility may be to improve handover latency; with a L3 handover and/or conditional the WTRU may (e.g., first) send a measurement report using RRC signaling. In response to this, for example, the network may provide a (e.g., further) measurement configuration and/or potentially a conditional handover configuration. With a handover, the network may provide a configuration for a target cell, for example, after the WTRU reports using RRC signaling that the cell meets a configured radio quality criteria.

One or more objectives of L1/2 based inter-cell mobility include a quick (e.g., efficient, fast) application of one or more configuration(s) for one or more candidate cells, including dynamically switching between Secondary Cells (SCells) and/or switching of the Primary Cell (PCell) (e.g., switch the roles between SCell and PCell) without performing RRC signaling. The inter-Centralized Unit (CU) case may not be included, as the inter-CU may include relocation of the Packet Data Convergence Protocol (PDCP (anchor and/or may have (e.g., already) been excluded from the work item. Therefore, an RRC based approach may be included (e.g., at least) to support inter-CU handover.

Furthermore, with the one or more legacy L3 handover mechanism(s), one or more (e.g., any) currently active SCell(s) may be released before the WTRU moves completes the handover to a target cell in the coverage area of another (e.g, new) site, and/or may (e.g., only) be added back after successful handover, which may lead to throughput degradation during handover. One or more of the aims of L1/2, therefore, may be to enable CA operation to be enabled instantaneously upon serving cell change.

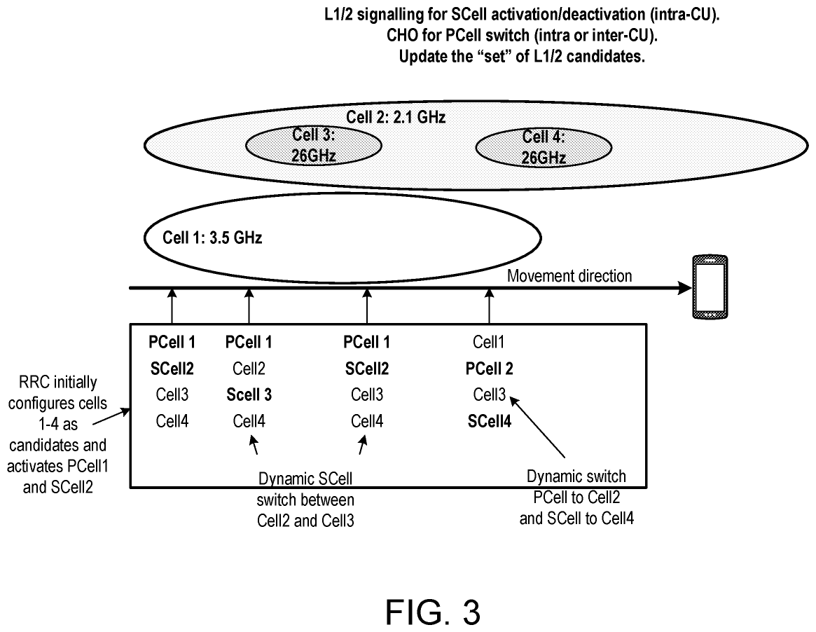

FIG. 3 depicts an example L1/2 inter-cell mobility operation. As shown in FIG. 2, a candidate cell group may be configured by RRC and/or a dynamic switch of PCell and SCell is achieved using L1/2 signaling. A WTRU may send a MeasurementReport message to the gNB. The gNB may determine to use lower layer (e.g., Layer1) Triggered Mobility (LTM) and/or may initiate LTM candidate preparation. The gNB may transmit an RRCReconfiguration message to the WTRU. The RRCReconfiguration message may include the configuration of one or more (e.g., multiple) LTM candidate target cells. The WTRU may store the configuration of one or more LTM candidate cell(s) and/or may transmit a RRCReconfigurationComplete message to the gNB. The WTRU may perform Downlink (DL) synchronization and/or timing advance (TA) acquisition with one or more candidate cell(s), for example, before receiving the LTM cell switch command. The WTRU may perform one or more L1 measurement(s) on the one or more configured LTM candidate cell(s), and/or may transmit one or more lower-layer measurement reports to the gNB. The lower-layer measurement reports may be carried on L1 or MAC. The gNB may determine to execute LTM cell switch to a target cell, and/or may transmit a MAC control element (CE) triggering LTM cell switch, for example, by including the candidate configuration index of the target cell. The WTRU may switch to the configuration of the LTM candidate target cell. The WTRU may perform random access (RA) procedure towards the target cell, for example, if the TA is not available. The WTRU may indicate successful completion of the LTM cell switch towards target cell.

A WTRU may be configured to perform random access. Physical random-access procedure may be triggered upon request of a PRACH transmission by one or more higher layer(s) and/or by a PDCCH order. A configuration by one or more higher layer(s) for a PRACH transmission may include one or more of the following: a configuration for PRACH transmission; and/or a preamble index, a preambleSubcarrier spacing (SCS), a corresponding RA-Radio Network Identifier (RA-RNTI), and/or a PRACH resource.

A PRACH may transmitted using the selected PRACH format. For Type-1 random access procedure, a WTRU may be provided a number N of SS/PBCH block indexes associated with one PRACH occasion and/or a number R of contention based preambles per SS/PBCH block index per valid PRACH occasion by ssb-perRACH-OccasionAndCB-PreamblesPerSSB.

The one or more PRACH occasion(s) may be mapped consecutively per corresponding SS/PBCH block index. The indexing of the PRACH occasion indicated by the mask index value may be reset per mapping cycle of consecutive PRACH occasions per SS/PBCH block index. The WTRU may select, for a PRACH transmission, the PRACH occasion indicated by PRACH mask index value for the indicated SS/PBCH block index in the (e.g., first) available mapping cycle.

The indicated preamble index may include an order of one or more PRACH occasions. For example, the (e.g., first) ordering of PRACH occasions may be based on and/or include an increasing order of one or more frequency resource index(es) for one or more frequency multiplexed PRACH occasion(s). For example, the (e.g., second) ordering of one or more PRACH occasion(s) may be based on and/or include an increasing order of one or more time resource index(es) for one or more time multiplexed PRACH occasion(s) within a PRACH slot. For example, the (e.g., third) ordering of one or more PRACH occasion(s) may be based on an increasing order of one or more index(es) for one or more PRACH slot(s).

The Random-Access procedure may be initiated by a PDCCH order, by the MAC entity itself, and/or by RRC for one or more (e.g., certain) event(s).

A WTRU may be configured with respect to transmission power of PRACH. A WTRU may determine a transmission power for a physical random access channel (PRACH), PRACH), P_{PRACH,b,f,c}(i) on active Uplink (UL) BWP b of carrier f of serving cell c based on DL RS for serving cell c in transmission occasion i. The WTRU may determine the transmission power for a PRACH based on Equation 1.

$${P}_{PRACH , b , f , c} ( i ) = min \{ {P}_{CMAX , f , c} ( i ) , {P}_{PRACH , target , f , c} + {PL}_{b , f , c} \} \qquad ( 1 )$$

The P_{CMAX,f,c}(i) may be the WTRU configured maximum output power for carrier f of serving cell c within transmission occasion i. P_{PRACH,target,f,c} may be the PRACH target reception power
PREAMBLE_RECEIVED_TARGET_POWER provided by one or more higher layers for the active UL BWP b of carrier f of cell c
PL_{b,f,c} may be a pathloss for the active UL BWP b of carrier f based on the DL RS associated with the PRACH transmission on the active DL BWP of cell c and calculated by the UE in dB as referenceSignalPower-higher layer filtered RSRP in dBm.
If the active DL BWP is the initial DL BWP and/or for SS/PBCH block and/or CORESET multiplexing pattern 2 or 3, for example, the WTRU may determine PL_{b,f,c} based on the SS/PBCH block associated with the PRACH transmission.

If a PRACH transmission from a WTRU is in response to a detection of a PDCCH order by the WTRU that triggers a contention-free random access procedure and/or depending on the DL RS that the DM-RS of the PDCCH order is quasi-collocated with, the referenceSignalPower may be provided by ss-PBCH-BlockPower. Additionally or alternatively, if the WTRU is configured resources for a periodic CSI-RS reception and/or the PRACH transmission is associated with a link recovery procedure (e.g., where a corresponding index q_{new} may be associated with a periodic CSI-RS configuration), the referenceSignalPower may be obtained by ss-PBCH-BlockPower and/or powerControlOffsetSS where powerControlOffsetSS may provided an offset of CSI-RS transmission power relative to SS/PBCH block transmission power. If powerControlOffsetSS is not provided to the WTRU, the WTRU may assume an offset of 0 dB. If the active TCI state for the PDCCH that provides the PDCCH order includes two RS, for example, the WTRU may expect that one RS is configured with qcl-Type set to ‘typeD’ and/or the WTRU may use the one RS when applying a value provided by powerControlOffsetSS.

The DCI for PDCCH order may be described as follows. If the CRC of the DCI format 1_0 is scrambled by C-RNTI and/or the Frequency domain resource assignment field comprises ones (e.g., all ones), the DCI format 1_0 may be associated with a random access procedure initiated by a PDCCH order, with one or more (e.g., all) remaining fields set as follows. A Random Access Preamble index field may include one or more (e.g., 6) bits, for example, according to ra-PreambleIndex. A UL and/or a supplemental uplink (SUL) indicator may include one bit. If the value of the Random Access Preamble index field is not zeros (e.g., all zeros) and/or if the WTRU is configured with a supplementaryUplink in a ServingCellConfig in the cell, for example, the Random Access Preamble index field may indicate which UL carrier in the cell to transmit the PRACH; otherwise, the Random Access Preamble index field may be reserved. The SS/PBCH index may include one or more (e.g., 6) bits. If the value of the Random Access Preamble index field is not zeros (e.g., all zeros), the SS/PBCH index field may indicate the SS/PBCH that may be used to determine the RACH occasion for the PRACH transmission; otherwise, the SS/PBCH index field may be reserved. The PRACH Mask index field may include one or more (e.g., 4) bits. If the value of the Random Access Preamble index is not zeros (e.g., all zeros), the PRACH Mask index field may indicate the RACH occasion associated with the SS/PBCH indicated by the SS/PBCH index field for the PRACH transmission; otherwise, the SS/PBCH index field may be reserved. One or more reserved bits may include one or more (e.g., 12) bits for operation in a cell with shared spectrum channel access in frequency range 1 and/or when the DCI format may be monitored in a common search space for operation in a cell in frequency range 2-2; otherwise, the reserved bits may include one or more (e.g., 10) bits.

In L1 mobility, a WTRU may be indicated to perform uplink timing alignment with a candidate cell before cell switch. The timing alignment may be performed by transmitting PRACH to the candidate cell. Under one or more scenario(s), such as insufficient WTRU transmit power, the PRACH may not be received and/or detected (e.g., reliably) to estimate the timing advance. The WTRU may be configured to include a power control mechanism to improve the reliability.

In examples, a WTRU may reset the power ramping counter for a first cell (e.g., may set the counter to 1). The WTRU may receive a PDCCH order for a RACH preamble transmission to a first cell (e.g., a candidate cell). For example, the WTRU may receive a PDCCH order for a physical RACH (PRACH) transmission to a first cell. The WTRU may determine a time difference between a time when the PDCCH order was received and a time when a previous PDCCH order was received.

If the ID of first cell indicated in the PDCCH order is the same ID as in a previous PDCCH order, and under the condition that the time difference between when the current PDCCH order and the previous PDCCH order was received is less than a threshold, the WTRU may perform one or more of the following. The WTRU may set a power ramping counter equal to the power ramping counter plus one (e.g., power ramping counter=power ramping counter +1). The WTRU may determine a PRACH power, for example, using the determined power ramping counter. The WTRU may transmit the PRACH, for example, using the determined PRACH power. For example, on a condition that an identifier of the first cell indicated in the PDCCH order is a same identifier received in a previous PDCCH order and a time difference between when the PDCCH order and the previous PDCCH order was received is below a threshold, the WTRU may increase a PRACH power by a power step and/or transmit the PRACH transmission at the increased PRACH power.

If the ID of cell indicated in the PDCCH order is the same ID as in a previous PDCCH order, and under the condition that the time difference between when the current PDCCH order and the previous PDCCH order was received is greater than or equal to a threshold, then the WTRU may perform one or more of the following. The WTRU may reset the power ramping counter. The WTRU may determine the PRACH power, for example, using the determined power ramping counter. The WTRU may transmit the PRACH, for example, using the determined PRACH power. For example, on a condition that the identifier of the first cell indicated in the PDCCH order is the same identifier received in the previous PDCCH order and the time difference between when the PDCCH order and the previous PDCCH order was received is at or above the threshold, the WTRU may reset the PRACH power and/or may transmit the PRACH transmission at the reset PRACH power.

In examples, a WTRU may receive a PDCCH order for a RACH preamble transmission to a cell (e.g., a candidate cell), where the PDCCH order may include a retransmission attempt index. For example, a WTRU may receive a PDCCH order for a RACH preamble transmission to a candidate cell, where the PDCCH order includes a retransmission attempt index. For an initial attempt, the WTRU may determine the initial attempt from the retransmission attempt index (e.g., being equal to zero). The WTRU may determine the transmit power for the initial attempt, for example, using the path loss determined from measurement of an associated RS (e.g., the SSB of the candidate cell with the largest RSRP). The WTRU may transmit the initial attempt using the determined transmit power.

For a retransmission attempt, if the current retransmission attempt index (n) equals the previous retransmission attempt index plus one (+1), the WTRU may determine the current transmit power by adding an offset to the previous transmit power. For example, when the retransmission attempt index indicates that the PRACH retransmission is a next PRACH transmission after a previous PRACH transmission attempt, the transmit power is increased by an offset of the transmit power for the previous PRACH transmission. If the current retransmission attempt index (n) does not equal the previous retransmission attempt index plus one (+1), the WTRU may determine a transmit power for the retransmission attempt by adding an offset to a transmit power corresponding to a last received (e.g., successfully received) PDCCH order. For example, when the retransmission attempt index indicates that the PRACH transmission is not a next PRACH transmission after a previous PRACH transmission attempt, the transmit power is increased based on a last successfully received PDCCH order. The WTRU may transmit the PRACH using the determined transmit power. For example, the WTRU may transmit the PRACH retransmission using a transmit power that is based on the retransmission attempt index.

In examples, a WTRU may measure a first candidate cell. The WTRU may send a CSI report to the serving cell. The CSI report may include one or more measurements of the first candidate cell. The measurement result(s) associated with the first candidate cell may be carried in L1 signaling and/or by MAC. The WTRU may receive a PDCCH order to transmit a preamble to the first candidate cell. The WTRU may determine a time difference between when the CSI report is sent and when the PDCCH order is received. If the time difference is less than a threshold, the WTRU may determine the first candidate cell to be a high priority cell, and/or the WTRU may calculate a PRACH transmit power by adding an offset to a determined power value. For example, on a condition that the time difference between when the CSI report is sent and when the PDCCH order is received at the WTRU is less than the threshold, the WTRU may transmit the PRACH at a second transmit power that is an offset greater than the first transmit power value. If the time difference is equal to or greater than a threshold, the WTRU may calculate the PRACH transmit power as a determined power value. The WTRU may transmit the PRACH with the determined PRACH transmit power. For example, on a condition that the time difference between when the CSI report is sent and when the PDCCH order is received at the WTRU is equal to or greater than a threshold, the WTRU may transmit a PRACH at a first transmit power value.

A WTRU may be configured with respect to one or more candidate cell set(s). The one or more candidate cell sets may be groups of one or more RRC configurations corresponding to a handover configuration for one or more candidate Special Cells (SpCells) and/or SCells. The one or more candidate cell set(s) may be modelled and/or received as one or more complete RRC Reconfiguration messages, one or more cell group configurations, and/or one or more cell configurations. One or more (e.g., each) of the candidate cell configuration(s) may include a candidate configuration identifier. One or more (e.g., each) of the candidate cell group(s) may include a candidate cell group identifier. If the grouping is performed at RRC, the switching between one or more different sets of candidate cells may include updating the serving cell indexes and/or one or more candidate configuration indexes which are used in L1 and/or MAC signalling to refer to (e.g., specific) indexes. For example, a MAC CE triggering the reconfiguration may include a candidate configuration index informing the WTRU which cell to perform the reconfiguration to.

A WTRU may be configured with respect to L1 measurement. A L1 measurement, as described herein, may include a measurement of RSRP, reference signal received quality (RSRQ), reference signal strength indicator (RSSI), etc, performed by a WTRU of a cell, beam, set of one or more cells, and/or set of one or more beams. L1 measurement may be performed on one or more CSI-RS resource(s) and/or on one or more SSBs. The terms CSI-RS and CSI-RS resource may be used interchangeably herein.

A WTRU may be configured to perform PRACH power control based on a transmission index within a PDCCH order. In examples, the WTRU may perform one or more of the following. The WTRU may receive a PDCCH order for a RACH preamble transmission to a cell (e.g., a candidate cell). The PDCCH order may indicate a retransmission attempt index. For example, the WTRU may receive a PDCCH order for a RACH preamble transmission to a candidate cell, where the PDCCH order includes a retransmission attempt index. The WTRU may determine the initial attempt from the retransmission attempt index (e.g., being equal to zero). The WTRU may determine the transmit power for the initial attempt, for example, using the path loss determined from measurement of an associated RS (e.g., the SSB of the candidate cell with the largest RSRP).

If the current retransmission attempt index (n) equals the previous retransmission attempt index plus one (+1), the WTRU may determine the current transmit power for a retransmission attempt by adding an offset to the previous transmit power. For example, when the retransmission attempt index indicates that the PRACH retransmission is a next PRACH transmission after a previous PRACH transmission attempt, the transmit power is increased by an offset of the transmit power for the previous PRACH transmission. If the current retransmission attempt index (n) does not equal the previous retransmission attempt index plus one (+1), the WTRU may determine the current transmit power for the retransmission attempt by adding an offset to transmit power corresponding to the last successfully received PDCCH order. For example, when the retransmission attempt index indicates that the PRACH transmission is not a next PRACH transmission after a previous PRACH transmission attempt, the transmit power is increased based on a last successfully received PDCCH order. The WTRU may transmit the PRACH using the determined transmit power. For example, the WTRU may transmit a PRACH retransmission using a transmit power that is based on the retransmission attempt index.

In examples, the value of the power ramping counter may be determined at least by an indication carrier in the PDCCH order. In examples, a WTRU may not be able to decode the PDCCH order (e.g., miss the PDCCH), and as a result, the WTRU may not transmit a PRACH. In examples, the WTRU may transmit a PRACH, but the target cell may not be able to detect the PRACH (e.g., due to PRACH transmit power not being sufficient). In examples, the WTRU may retransmit the PRACH with a higher transmit power than the previous transmission. In examples, the WTRU may use the same transmit power for the transmission (e.g., if the WTRU is unable to decode the PDCCH order and/or unable to transmit the PRACH).

In examples, the transmit power of the PRACH may be determined based on a successfully detected PDCCH order. A PDCCH order may be associated to a transmission index. A WTRU may determine, based on the transmission index, the count of successfully detected PDCCH, which may be used to determine the PRACH power. The transmission index may be carried in the PDCCH order. The transmission index may be used to determine the value of a power ramping counter, for example the PREAMBLE_POWER_RAMPING_COUNTER.

The WTRU may determine the PDCCH index and/or the count with one or more of the following methods.

In examples, the PDCCH transmission may include DCI. The DCI of the PDCCH order may include a transmission index. The WTRU may determine the transmit power based on a transmission index included in the DCI. The DCI may include a bitfield. A bitfield in the DCI may indicate the transmission index. The WTRU may determine the transmit power based on the bitfield. For example, if two bits are used, 00 may indicate transmission index 0, 01 may indicate transmission index 1, 10 may indicate transmission index 2, and 11 may indicate transmission index 3. The WTRU may expect the transmission indices in the initial PDCCH order and/or one or more subsequent PDCCH order(s) to be in order. For example, the DCI for the initial PDCCH order may include transmission index 0. The DCI for one or more subsequent PDCCH order(s) may include transmission indices 1, 2, etc. One or more subsequent PDCCH orders (e.g., in this context) may be PDCCH orders that indicate a retransmission of PRACH to the same PCI and/or with the same RS index as the initial PRACH transmission.

For one or more (e.g., each) successfully received DCI (e.g., the WTRU may detect one or more (any) missed DCI from out-of-order index value), the WTRU may increase a counter. The initial value of the counter may be set to 1. The WTRU may determine the transmit power based on an association of a counter and the retransmission attempt index.

TABLE 1

| Transmission index | counter | PRACH index n |
|---|---|---|
| 0 (detected) | 1 | 1 |
| 1 (not detected) | N/A | N/A (PRACH not transmitted due to |
| | | missed DCI) |
| 2 (detected) | 2 | 2 |
| 3 (detected) | 3 | 3 |

depicts an example of the transmission index, counter, and PRACH index n

The initial PDCCH order (e.g., according to Table 1), may include an transmission index value of 0. The WTRU, upon receiving the PDCCH order, for example, may set the power ramping counter to an initial value (e.g., 1). For example, the WTRU may receive configuration information including an association of the retransmission attempt index and the transmit power to determine the transmit power based on the association of the received retransmission attempt index and the configured transmit power. Additionally or alternatively, the power ramping counter may be initialized by the WTRU earlier and/or the WTRU may keep the value of the power ramping counter unchanged if the transmission index is determined to be 0. The second PDCCH order detected may include a transmission index value of 1, and/or the counter may be incremented by 1. If the second PDCCH order detected includes a transmission index value of 2 but not a transmission index value of 1, for example, the WTRU may increase the power ramping counter by 1 and/or set the counter to 2. The WTRU may infer that a previous PDCCH order with index 1 has been missed.

In examples, there may be a one-to-one mapping between the index in the PDCCH order and the power ramping counter. For example, the WTRU may set the counter as follows: counter=index; or counter=index+1. In examples, an index and/or the corresponding counter value indicated by the index may be configured and/or the WTRU may use the corresponding counter value when it receives an index in a PDCCH order (e.g., a set of index values and/or corresponding counter values may be configured). For example, indices 0, 1, 2, and 3 may correspond to counter values 1, 2, 3, and 4. One or more similar (e.g., same) methods may be applicable regardless of the number of possible indices. For example, one or more similar (e.g., same) methods may be applicable when a single bit is used to indicate one of two indices.

TABLE 2

| Transmission index | counter | PRACH index n |
|---|---|---|
| 0 (detected) | 1 | 1 |
| 1 (not detected) | N/A | N/A (PRACH not transmitted |
| | | due to missed DCI) |
| 0 (detected) | 2 | 2 |
| 1 (detected) | 3 | 3 |

depicts an example where the transmission index reaches the maximum value as the counter and PRACH index n increase

In examples, when the transmission index reaches the maximum value, for example, the transmission index may reset. For example, if a single bit is used for the index, the transmission index may reset when the transmission index reaches the maximum value of 1 (e.g., the WTRU may receive DCI with indices 0, 1, 0, etc.). For example, the WTRU may reset the retransmission attempt index when the retransmission attempt index reaches a maximum value.

The power ramping counter may reset if the time between two PDCCH orders is larger than a threshold. Unless otherwise noted, the terms counter, power ramping counter, and/or PREAMBLE_POWER_RAMPING_COUNTER may be used interchangeably herein.

In examples, a 1-bit index in the PDCCH order may indicate whether to set and/or reset the power ramping counter and/or increment the power ramping counter. For example, when the WTRU receives a PDCCH order and/or determines the index to be 0, the WTRU may set and/or reset the power ramping counter to an initial value, (e.g., 1). The power ramping counter may be set to the initial value before receiving the first PDCCH order and/or (e.g., then) when index 0 is received, for example, the power ramping counter may be kept unchanged. When the WTRU receives a PDCCH order and/or determines the index to be 1, for example, the WTRU may increment the power ramping counter by 1. Table 3 illustrates an example for this approach.

TABLE 3

| Transmission index | counter | PRACH index n |
|---|---|---|
| 0 | 1 | 1 (initial transmission) |
| 1 | 2 | 2 (1st retransmission) |
| 1 | 3 | 3 (2nd retransmission) |
| 1 | 4 | 4 (3rd retransmission) |

depicts an example where the counter increments by 1 when the transmission index is determined to be 1.

Incrementing the counter may be based on at least the time when a PDCCH order is received. The counter may be incremented if the PDCCH order for retransmission is received (e.g., only) within a time interval of the previous PDCCH order. For example, the PDCCH retransmission may be associated with an index that is one value greater than an index associated with the previous PRACH transmission. One or more of the following scenarios may depict how the counter may be incremented.

In examples, a WTRU may receive a PDCCH order with 1-bit indication value 0 (e.g., an initial transmission of PRACH). Within T ms of the first order, for example, the WTRU may receive a PDCCH order (e.g., to the same target cell and/or with the same RS index) with 1-bit indication value 1 (e.g., a retransmission of PRACH). The WTRU may increase the power ramping counter, calculate the PRACH power, and/or transmit PRACH. Within T ms of the second PDCCH order, for example, the WTRU may receive a PDCCH order (e.g., to the same target cell and/or with the same RS index) with 1-bit indication value 1 (e.g., a retransmission of PRACH). The WTRU may increase the power ramping counter, calculate the PRACH power, and/or transmit PRACH.

In examples, a WTRU may receive a PDCCH order with 1-bit indication value 0 (e.g., an initial transmission of PRACH). Within T ms of the first PDCCH order, for example, the WTRU may receive a PDCCH order (e.g., to the same target cell and/or with the same RS index) with 1-bit indication value 1 (e.g., a retransmission of the PRACH). The WTRU may increase the power ramping counter. The WTRU may receive a PDCCH order (e.g., to the same target cell and/or with the same target cell and/or with the same RS index) with 1-bit indication value 1 (e.g., a retransmission of PRACH but the time from the reception of the previous PDCCH order is more than T ms. In this case, for example, the WTRU may infer that there was another PDCCH order for another (e.g., new) initial transmission (e.g., which may have been missed) and/or the WTRU may not increment the counter. In examples, the WTRU may reset the counter to the initial value, calculate the transmit power, and/or transmit PRACH. In examples, the WTRU may reset the counter to the initial value, increment by one, calculate the transmit power, and/or transmit PRACH.

The time T may be measured using a timer. For example, the WTRU may start a timer and/or may increment the power ramping counter if a PDCCH order for retransmission is received before the timer expires.

In examples, the first PDCCH order received by the WTRU may include index 1 (e.g., instead of index 0). The WTRU may follow the same procedures described herein, and/or may increment the counter (e.g., if the counter was set to an initial value).

In examples, the transmission index may be associated with a control resource set (CORESET) in which the PDCCH is received. For example, if the PDCCH is received in CORESET 1, the WTRU may determine the transmission index to be 0; and if the PDCCH is received in CORESET 2, the WTRU may determine the transmission index to be 1. The WTRU may determine the retransmission attempt index based on an association of the retransmission attempt index and a CORESET in which the PDCCH is received.

In examples, the transmission index may be associated to the Radio Network Identifier (RNTI) of the PDCCH order.

The WTRU may determine PRACH power using the counter value. For example, PRACH Tx Power=preambleReceivedTargetPower+DELTA_PREAMBLE+(PREAMBLE_POWER_RAMPING_COUNTER−1)×PREAMBLE_POWER_RAMPING_STEP)+Pathloss, where PREAMBLE_POWER_RAMPING_COUNTER may be equal to the PDCCH count value. For example, PRACH Tx Power (n)=PRACH Tx Power (n−1)+Offset, where the value of Offset may be configured and/or indicated and/or n is the PRACH index.

In examples, the WTRU may include a validity timer for one or more PDCCH order(s) associated to a target cell. The validity timer may be started and/or restarted when a PDCCH order is received. For example, the WTRU may start and/or restart a validity timer when a PDCCH order is received. If the validity timer expires, for example, the WTRU may reset the counter value for that target cell. For example, the WTRU may reset a counter value for the candidate cell when the validity timer expires. When the validity timer expires, for example, the WTRU may expect the first PDCCH order for the same target cell to include transmission index 0. If the first PDCCH order does not have transmission index 0, for example, the WTRU may determine that the PDCCH order with transmission index 0 was missed.

In examples, the counter may be a fixed value. The WTRU may determine the transmit power based on the retransmission attempt index and the fixed value. For example, the WTRU may set and/or may be indicated to set the power ramping counter PREAMBLE_POWER_RAMPING_COUNTER to a fixed value (e.g., 1). For example, the WTRU may not change (e.g., increment) the power ramping counter value. The WTRU may use the same counter value for PRACH retransmissions and/or initial PRACH transmission. The WTRU may use the same counter value for PRACH retransmissions and an initial PRACH transmission when one or more of the following apply. The WTRU may use the same counter value for PRACH retransmissions and/or initial PRACH transmission when the WTRU is configured to perform lower layer triggered mobility (LTM), is performing LTM, and/or is indicated with a PDCCH order to transmit PRACH to a specific cell, e.g., a cell other than its own serving cell. The WTRU may use the same counter value for PRACH retransmissions and an initial PRACH transmission when the WTRU is configured to perform LTM, is performing LTM, and/or is indicated with a PDCCH order to transmit PRACH to a specific cell, e.g., a cell that is one of the cells in a configured LTM set and/or in an active LTM set. The WTRU may use the same counter value for PRACH retransmissions and an initial PRACH transmission when the WTRU is using a (e.g., specific) PRACH occasion for PRACH transmission. For example, when the WTRU uses a PO from a first set of configured PRACH occasions, the WTRU may be expected to fix the counter value. The set of configured PRACH occasions may be used to transmit PRACH to a specific set of cells, e.g., a set of non-serving cells and/or a set of cells in an active LTM set.

The WTRU may use the same counter value for PRACH retransmissions and an initial PRACH transmission when the RNTI of the PDCCH order indicates whether to fix the power ramping counter value. The WTRU may use the same counter value for PRACH retransmissions and an initial PRACH transmission when the PDCCH order includes a cell identifier, e.g., a PCI. The WTRU may use the same counter value for PRACH retransmissions and an initial PRACH transmission when the WTRU is using a specific preamble (e.g., a preamble allocated for one or more LTM procedures). The WTRU may use the same counter value for PRACH retransmissions and an initial PRACH transmission when one or more (e.g., any) other mechanisms (e.g., a configuration and/or a field in the PDCCH order) imply that the PDCCH order is ordering to the WTRU to initiate PRACH transmission as part of a mobility procedure.

When the power ramping counter is kept fixed, the WTRU may be indicated to apply an offset to a determined PRACH transmit power. The offset may be configured and, for example, may be set to the same value as the power ramping step. In examples, the methods (e.g., techniques) provided herein may be (e.g., similarly) applicable with the difference that the counter variable kept at the WTRU may not be used to set the value of the PREAMBLE_POWER_RAMPING_COUNTER but the value of another counter parameter (e.g., NEW_POWER_RAMPING_COUNTER). In examples, (e.g., then) the PRACH transmit power may be calculated as: PRACH Tx Power=preambleReceivedTargetPower+DELTA_PREAMBLE+(PREAMBLE_POWER_RAMPING_COUNTER−1)×PREAMBLE_POWER_RAMPING_STEP)+Pathloss+(NEW_POWER_RAMPING_COUNTER−1)×offset. Additionally or alternatively, one or more methods described herein that include time T may be implemented (e.g., similarly implemented) herein.

In examples, the PREAMBLE_POWER_RAMPING_COUNTER may be fixed, for example to 1, and the PDCCH order may indicate whether to add an offset power value to the transmit power of a previous PRACH transmission. The WTRU may not be expected to increment the PREAMBLE_POWER_RAMPING_COUNTER for one or more retransmissions. In examples, the (e.g., new) power ramping counter may not be included (e.g., the index directly controls the transmit power). For example, with 1-bit indication, the following may apply:

TABLE 4

| Transmission | | |
|---|---|---|
| index | PRACH power | PRACH index n |
| 0 | Power(1) = Initial transmit power | 1 (initial transmission) |
| 1 | Power(2) = Power(1) + offset | 2 (1st retransmission) |
| 1 | Power(3) = Power(2) + offset | 3 (2nd retransmission) |
| 1 | Power(4) = Power(3) + offset | 4 (3rd retransmission) |

depicts an example of calculating PRACH power based on one or more retransmissions

The WTRU may calculate (e.g., according to table 4), an initial PRACH power and/or use that (e.g., initial PRACH) power when a PDCCH order with index 0 is received. When a subsequent PDCCH order is received for a retransmission (e.g., to the same PCI and/or with the same RS index as the initial PDCCH order), the WTRU may increase the previous PRACH power by an offset and/or send the subsequent (e.g., new) PRACH with the (e.g., new) determined (e.g., calculated) power. In examples, if the WTRU receives a PDCCH order with index 1 but not index 0, the WTRU may follow the procedure shown in Table 4, e.g., the WTRU may determine the PRACH power as initial power+offset where the initial power may be calculated as preambleReceivedTargetPower+DELTA_PREAMBLE+ (PREAMBLE_POWER_RAMPING_COUNTER−1)×PREAMBLE_POWER_RAMPING_STEP)+Pathloss and/or where the power ramping counter is fixed to 1.

Similar to the one or methods described herein, adding an offset power may be based on at least the time when a PDCCH order is received. One or more of the following examples may illustrate the methods described herein (e.g., using the same power values as in Table 4).

In examples, a WTRU may receive a PDCCH order with 1-bit indication value 0 (e.g., an initial transmission of PRACH). The WTRU may transmit PRACH with Power (1). Within T ms of the first PDCCH order, for example, the WTRU may receive a PDCCH order (e.g., to the same target cell and/or with the same RS index) with 1-bit indication value 1 (e.g., a retransmission of PRACH). The WTRU may increase the transmission power by adding an offset, calculate the PRACH power as Power (2), and/or transmit PRACH. Within T ms of the second PDCCH order, for example, the WTRU may receive a PDCCH order (e.g., to the same target cell and/or with the same RS index) with 1-bit indication value 1 (e.g., a retransmission of PRACH). The WTRU may increase the power to Power (3) and/or transmit PRACH.

In examples, a WTRU may receive a PDCCH order with 1-bit indication value 0 (e.g., an initial transmission of PRACH). The WTRU may transmit PRACH with Power (1). Within T ms of the first PDCCH order, for example, the WTRU may receive a PDCCH order (e.g., to the same target cell and/or with the same RS index) with 1-bit indication value 1 (e.g., a retransmission of PRACH). The WTRU may increase the transmission power by adding an offset, calculate the PRACH power as Power (2), and/or transmit the PRACH. The WTRU may receive a PDCCH order (e.g., to the same target cell and/or with the same RS index) with 1-bit indication value 1 (e.g., a retransmission of PRACH but the time difference between the reception of this PDCCH order and the reception of the previous PDCCH order is more than T ms. In this case, the WTRU may infer that there was another PDCCH order for another (e.g., new) initial transmission (e.g., which may have been missed). In examples, the WTRU may calculate the transmission power without adding an offset and/or transmit PRACH. In examples, the WTRU may calculate the transmission power by adding the offset once (e.g., instead of two times), and/or transmit the PRACH.

The time T may be measured from the time PDCCH order is received (e.g., the slot in which the PDCCH order is received). Time T may be measured in one or more other ways (e.g., options). For example, the time T may be measured from when the PRACH is transmitted (e.g., the slot in which the PRACH is transmitted, etc.).

A WTRU may receive a physical downlink control channel (PDCCH) order for a physical random access channel (PRACH) transmission to a first cell. The WTRU may, on a condition that an identifier of the first cell indicated in the PDCCH order is a same identifier received in a previous PDCCH order and a time difference between when the PDCCH order and the previous PDCCH order was received is below a threshold, increase a PRACH power by a power step and/or transmit the PRACH transmission at the increased PRACH power. The WTRU may, on a condition that the identifier of the first cell indicated in the PDCCH order is the same identifier received in the previous PDCCH order and the time difference between when the PDCCH order and the previous PDCCH order was received is at or above the threshold, reset the PRACH power and/or transmit the PRACH at the reset PRACH power. Resetting the PRACH power may include determining the PRACH power without the power step and/or with a multiplier of the power step set to 0.

The PDCCH order may include a physical cell identity (PCI), an index associated with the first cell, and/or a reference signal (RS). The WTRU may determine that a PCI indicated in the PDCCH order is the same PCI received in the previous PDCCH order. The WTRU may determine that an index associated with the first cell in the PDCCH order is the same index associated with the first cell received in the previous PDCCH order. The WTRU may determine that an RS in the PDCCH order is the same RS received in the previous PDCCH order.

The WTRU may determine the power step based on a power control field. The WTRU may determine the power step based on a reference signal. The PDCCH order may include a synchronization signal block (SSB) index and/or a channel state interference-RS (CSI-RS) index. The WTRU may determine a random-access occasion (RO) in which to transmit the PRACH transmission.

The WTRU may start a timer, for example, when the first PDCCH order is received to determine to increase the PRACH power. The WTRU may increase the PRACH power based on an explicit indication included in the PDCCH order. The WTRU may increase the PRACH power based on a power ramping counter value. The WTRU may update and/or reset the power ramping counter value.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1.-22. (canceled)

23. A wireless transmit/receive unit (WTRU) comprising:
a processor configured to:
receive a physical downlink control channel (PDCCH) order for a random access channel (RACH) preamble transmission to a candidate cell, wherein the PDCCH order comprises a retransmission attempt index; and
transmit a physical RACH (PRACH) retransmission using a transmit power that is based on the retransmission attempt index,
wherein, when the retransmission attempt index indicates that the PRACH retransmission is a next PRACH transmission after a previous PRACH transmission attempt, the transmit power is increased by an offset of the transmit power for the previous PRACH transmission, and
wherein, when the retransmission attempt index indicates that the PRACH transmission is not a next PRACH transmission after a previous PRACH transmission attempt, the transmit power is increased based on a last successfully received PDCCH order.

24. The WTRU of claim 23, wherein the PDCCH transmission comprises downlink control information (DCI), and wherein the processor is further configured to determine the transmit power based on a transmission index comprised in the DCI.

25. The WTRU of claim 24, wherein the DCI comprises a bitfield, and wherein the processor is further configured to determine the transmit power based on the bitfield.

26. The WTRU of claim 23, wherein the processor is further configured to:
receive configuration information comprising an association of the retransmission attempt index and the transmit power to determine the transmit power based on the association of the received retransmission attempt index and the configured transmit power.

27. The WTRU of claim 23, wherein the processor is configured to reset the retransmission attempt index when the retransmission attempt index reaches a maximum value.

28. The WTRU of claim 23, wherein the processor is further configured to determine the retransmission attempt index based on association of the retransmission attempt index and a control resource set (CORESET) in which the PDCCH is received.

29. The WTRU of claim 23, wherein the processor is further configured to start or restart a validity timer when a PDCCH order is received.

30. The WTRU of claim 29, wherein the processor is further configured to reset a counter value for the candidate cell when the validity timer expires.

31. The WTRU of claim 23, wherein the processor is further configured to determine the transmit power based on an association of a counter and the retransmission attempt index.

32. The WTRU of claim 31, wherein the counter is a fixed value, and the processor is further configured to determine the transmit power based on the retransmission attempt index and the fixed value.

33. The WTRU of claim 23, wherein the PDCCH retransmission is associated with an index that is one value greater than an index associated with the previous PRACH transmission.

34. A method performed by wireless transmit/receive unit (WTRU), the method comprising:
receiving a physical downlink control channel (PDCCH) order for a random access channel (RACH) preamble transmission to a candidate cell, wherein the PDCCH order comprises a retransmission attempt index; and
transmitting a physical RACH (PRACH) retransmission using a transmit power that is based on the retransmission attempt index,
wherein the method further comprises, when the retransmission attempt index indicates that the PRACH retransmission is a next PRACH transmission after a previous PRACH transmission attempt, increasing the transmit power by an offset of the transmit power for the previous PRACH transmission, or
wherein the method further comprises, when the retransmission attempt index indicates that the PRACH transmission is not a next PRACH transmission after a previous PRACH transmission attempt, increasing the transmit power based on a last successfully received PDCCH order.

35. The method of claim 34, wherein the PDCCH transmission comprises downlink control information (DCI), and wherein the method further comprises determining the transmit power based on a transmission index comprised in the DCI.

36. The method of claim 35, wherein the DCI comprises a bitfield, and wherein the method further comprises determining the transmit power based on the bitfield.

37. The method of claim 34, further comprising:
receiving configuration information comprising an association of the retransmission attempt index and the transmit power to determine the transmit power based on the association of the received retransmission attempt index and the configured transmit power.

38. The method of claim 34, further comprising resetting the retransmission attempt index when the retransmission attempt index reaches a maximum value.

39. The method of claim 34, further comprising determining the retransmission attempt index based on an association of the retransmission attempt index and a control resource set (CORESET) in which the PDCCH is received.

40. The method of claim 34, further comprising starting or restarting a validity timer when a PDCCH order is received.

41. The method of claim 40, wherein the method further comprises resetting a counter value for the candidate cell when the validity timer expires.

42. The method of claim 34, further comprising determining the transmit power based on an association of a counter and the retransmission attempt index.

43. The method of claim 42, wherein the counter is a fixed value, and the method further comprising determining the transmit power based on the retransmission attempt index and the fixed value.

44. The method of claim 34, wherein the PDCCH retransmission is associated with an index that is one value greater than an index associated with the previous PRACH transmission.
